(19) United States
(12) Patent Application Publication
(10) Pub. No.: US 2026/0221112 A1
(43) Pub. Date: Jul. 30, 2026

(54) INFORMATION HANDLING SYSTEM DISPLAY IMAGE MANAGEMENT DURING POWER TRANSITIONS

(71) Applicant: Dell Products L.P., Round Rock, TX (US)

(72) Inventors: Chih-Hao Kao, Singapore (SG); Dung Loung Hii, Singapore (SG); Yonggu Kang, Singapore (SG)

(73) Assignee: Dell Products L.P., Round Rock, TX (US)

(21) Appl. No.: 19/036,640

(22) Filed: Jan. 24, 2025

(51) Int. Cl. G09G 3/36

(52) U.S. Cl. CPC G09G 3/3611; G09G 2300/0452; G09G 2300/0478; G09G 2330/02

(57) ABSTRACT

An information handling system display presents visual images with LED backlights having potassium fluorosilicate phosphor to enhance illumination through a liquid crystal display (LCD) panel having an array of pixels. At power down the phosphor decreases illumination at a decay rate that produces a reddish afterglow at the display panel. To avoid the reddish afterglow and other garbage images, the display shuts off power to the display panel within a predetermined time of shutting off the backlight, such as a simultaneous power off the array of pixels and the backlight so that the array of pixels blocks light passage when the liquid crystals transition to a dark state.

### BACKGROUND OF THE INVENTION

### Field of the Invention

The present invention relates in general to the field of information handling system displays, and more particularly to an information handling system display image management during power transitions.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information with a processor that executes instructions in cooperation with a memory that stores the instructions and information. Stationary information handling systems, such as desktop, tower and server configurations, integrate processing components in a housing that operates at a fixed location with external resources, such as a power outlet and peripheral input devices. For instance, a typical stationary information handling system interfaces with a peripheral display to present information as visual images, a peripheral keyboard to accept key inputs and a peripheral mouse to accept cursor movement inputs. Portable information handling systems integrate the processor, memory, display, keyboard and a battery power source in a portable housing to support mobile operations. Portable information handling systems allow end users to carry a system between meetings, during travel, and between home and office locations so that an end user has access to processing capabilities while mobile. In addition to these integrated input/output devices, portable information handling systems will also typically interact with peripheral devices, such as a peripheral display.

Typical information handling system displays have a flat panel configuration to reduce the display thickness and weight. One type of flat panel display is a liquid crystal display (LCD) that presents images by changing the orientation of liquid crystals in a display panel to adjust the color of light that passes through the display panel from a backlight located behind the display panel. A typical LCD backlight uses light emitting diode (LED) illumination that is diffused evenly behind the LCD panel. Generally, LCD backlights attempt to output white light by combining different colored LED's, such as red, green and blue light producing LEDs. A recent improvement for LED output is to include potassium fluorosilicate (KSF) phosphor as an efficient way to boost color space with distinctive spikes of red energy to enhance red color purity. A difficulty with including KSF phosphor is that illumination from the phosphor once excited by the underlying LED has a relatively long decay time that can produce an instantaneous residual reddish flash observable through the LCD panel when LED backlight power is turned off while the LCD panel is in a non-black pattern. In order to mitigate and address this reddish flash, display panel manufacturers have introduced a timing sequence to the panel specification that introduces a 20 ms delay before turning off the LED backlight to insert a black pattern at the LCD panel. The 20 ms delay, however, increases the timing gap by more than a frame before the black pattern can be fully inserted with a scan of black pixel values from the display timing controller, typically a 24 ms process. As a result of the increment of the timing gap of more than a frame before the black pattern can be fully inserted, video garbage and white lines become observable at the display panel. That is the screen garbage and white lines result from desynchronization with the frame sequence during timing change or input source change. The presentation of screen garbage detracts from the end user experience.

### SUMMARY OF THE INVENTION

Therefore, a need has arisen for a system and method which manages display image presentation during power transitions.

In accordance with the present invention, a system and method are provided which substantially reduce the disadvantages and problems associated with previous methods and systems to manage display image presentations during power transitions. An array of pixels of a display panel have power shut off within a predetermined time of shutting off a backlight so that the pixels transition to a dark state to block passage of illumination through the display panel.

More specifically, an information handling system processes information with a processor that executes instructions in cooperation with a memory that stores the instructions and information. The information is presented at a display as visual images defined in an array of pixels and illuminated by an LED backlight having red potassium fluorosilicate phosphor to enhance light quality. At a command to power down, the display scalar cuts off power to the display backlight and the display panel pixels in a predetermined temporal arrangement so that the pixels revert to a power state that blocks the passage of red phosphor light as the red phosphor illumination decays following backlight power down. In one example embodiment, the scalar cuts off power to the display panel pixel array and backlight simultaneously so that the pixels transition quickly to a block light, such as in approximately 8 ms, a time of one-third of the scan time to scan black values to the pixels.

The present invention provides a number of important technical advantages. One example of an important technical advantage is that a display transitions to a power down state without presenting garbage related to phosphor illumination decay or scanning of black values to the display pixels in a normal pixel scan time. A power off to all of the pixels at the same time results in all pixels simultaneously reverting to a black state that prevents presentation of reddish phosphor decay illumination. The reversion to the off state occurs in a fraction of the time needed for a full scan of black to all the pixels so that garbage related to a full scan during backlight illumination is also avoided.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system interfaced with a display that manages visual image presentation during a transition to a low power state;

FIGS. 2 and 2A depicts a block diagram of a display panel configured to time power shut off to a display panel and backlight; and

FIG. 3 depicts a flow diagram of a process for transition to power down at a display that manages visual image presentation.

### DETAILED DESCRIPTION

An information handling system display manages presentation of undesired visual image garbage during transition to a power down state. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

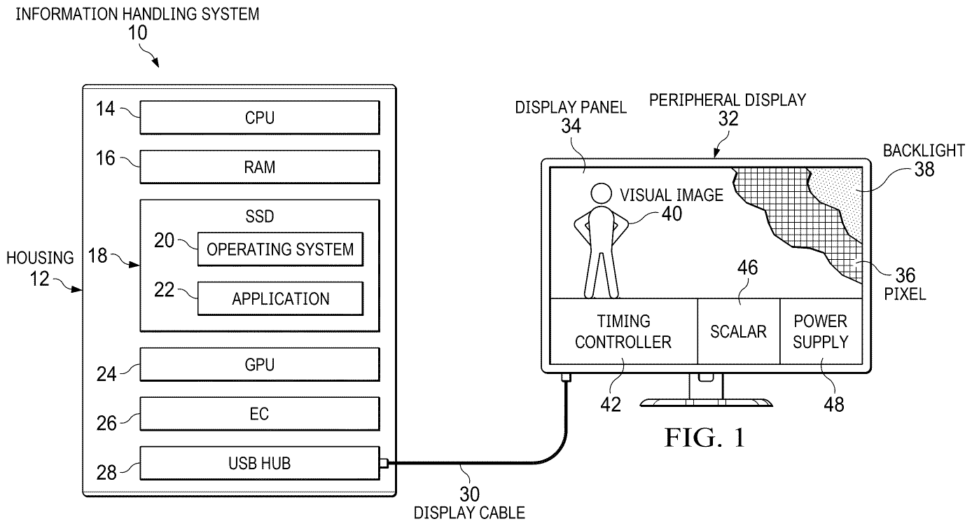

Referring now to FIG. 1, a block diagram depicts an information handling system 10 interfaced with a display 32 that manages visual image presentation during a transition to a low power state. Information handling system 10 processes information with processing components coupled in a housing 12. In the example embodiment, housing 12 has a stationary configuration that presents information as visual images 40 at a peripheral display 32. In an alternative embodiment, information handling system 10 may have a portable configuration that integrates display 32 into housing 12 and also interfaces with a peripheral display. A central processing unit (CPU) 14 executes instructions to process information in cooperation with a random access memory (RAM) 16 that stores the instructions and information. A solid state drive (SSD) 18 provides non-transient memory that stores instructions and information during power down of the system. For example, an operating system 20 coordinates interactions between processing components and supports execution of applications 22. A graphics processing unit (GPU) 24 interfaces with CPU 14 to further process information to define visual images, such as by defining pixel values that are communicated to peripheral display 32 through a display cable 30. An embedded controller 26 manages operational conditions within housing 12, such as application of power and interactions with peripheral devices. A USB hub 28 manages communication with external devices through USB communications.

In the example embodiment, peripheral display 32 receives and presents information as visual images 40 by scanning pixel values provided by display cable 30 with timing controller 42 to pixels 36 of a display panel 34. A backlight 38 provides white light illumination through pixels 36 to illuminate the visual image so as to be visible to an end user viewing the display. A scalar 46 includes a processing resource and non-transient memory that stores instructions for managing presentation of visual images at peripheral display 32. For example, scalar 46 manages the resolution of visual images provided by GPU 24 so that timing controller 42 scans pixel values to the array of pixels 36 in a correct pattern. In one example embodiment, a complete scan of pixel values to display panel 34 for the array of pixels 36 takes substantially 24 ms. Scalar 46 also manages operational control of display parameters input at the display, such as through an onscreen display (OSD) menu presented at display panel 34. For instance, scalar 46 controls brightness, contrast, input source selection and other factors. Scalar 46 interfaces with a power supply 48 to manage application of power to the display components.

In the example embodiment, display panel 34 has liquid crystal display (LCD) pixels 36 that selectively block passage of light so that visual images are created with different combinations of red, green and blue light. For example, each pixel 36 has a red liquid crystal material that selectively blocks red light, a blue liquid crystal material that selectively blocks red light and a green liquid crystal material that selective blocks green light. At each pixel different combinations of red, green and blue light combine to present a pixel color. The array of pixels have pixel values scanned by the timing controller so that visual images are defined with the array of colors created by light passing through the red, green and blue pixels. Backlight 38 generates white light with light emitting diodes (LEDs) that generate white light by combining red, green and blue light. In order to enhance the quality of the light provided, backlight 38 includes phosphors that enhance the red, green and blue light quality. For example, backlight 38 includes potassium fluorosilicate (KSF) and similar phosphor materials that absorb light and then emit light in a desired frequency. A difficulty with the inclusion of phosphors is that, when the LEDs are turned off to no longer produce light that excites the phosphors, the phosphors will continue to emit light over a decay time so that the phosphor light will illuminate the pixels for the decay time. With KSF phosphor material, the illumination over the decay time is presented through display panel 34 as a gradually diminishing reddish color. Alternatively, some displays attempt to scan black pixel values to pixels 34 to block the reddish light, however, scanning the black pixels to display panel 34 generates screen garbage until the scan is complete.

To manage presentation of visual images at display panel 34 during a transition to a power down state, scalar 46 executes instructions that power down pixels 36 within a predetermined time of power down of backlight 38 so that the pixels have dark state that prevents backlight reddish illumination from passing through the pixels. For example, when scalar 46 receives a power down command it simultaneously cuts power to both the pixels 36 and backlight 38. At removal of power, pixels 36 transition to a dark state in a uniform manner and in a transition time, such as 8 msec for one example display panel. Uniform transition to a dark state across all pixels in a fraction of a display panel frame scan time quickly subdues the decaying illumination of the phosphors and prevents display of screen garbage that can present during a frame scan. Although a simultaneous power down of the display panel and backlight provides a smooth transition to a blank screen at display panel 34 during transition of the display to an off state, in alternative embodiments other types of timings may be used. For example, independent control of power to the backlight and the display panel will allow power down of pixels 36 by cutting off power to display panel 34 before cutting off power to backlight 38. In one example embodiment, the backlight is turned off after a delay of the transition to the dark off state by the pixel liquid crystal material, such as 8 ms. In one alternative embodiment, power may be cut off to the display panel 34 as sets of pixels, such as cutting off all red pixels at a first time, all green pixels at a second time and all blue pixels at a third time. These power downs may be coordinated with independent shutdowns of red, green and blue LEDs of a backlight. Various combinations of power control for LEDs and pixels may be helpful to provide a more smooth transition to display off states depending on the types of display components included in a display. For instance, analog power control to pixels 36 may provide a decay of power uniformly across the pixels to an off state that is proportional and/or matched to the decay time of various phosphors included in the display panel.

In various embodiments, a removal of power from the LCD pixels may be performed where screen garbage may be present. One example is when the display turns off where the scalar turns of power to the LCD panel pixels so that aftereffects of phosphor during power down of the backlight are not visible through the LCD pixels. In such a situation, simultaneous power down of the backlight helps alleviate all screen garbage where the LCD pixels translate to a dark state in a fraction of frame scan time, such as 8 ms for a panel with a 24 ms scan time. In other examples, other types of input timing changes may initiate a power down of the LCD pixels whether or not the backlight is powered down. For example, at a resolution change, a cable plug or unplug, a PBP/PIP initiation or termination and an input source change, a power down of the LCD pixels resolves presentation of undesired images during the transition after which visual images may again be presented with a power up of the LCD pixels followed by initiating of pixel value scans. In one example embodiment, at the input timing change, both the LCD pixels and the backlight power down to remove screen garbage, then the LCD pixels power up to accept a frame scan from the timing controller before the backlight powers on so that the end user is greeted with a visual image as the backlight resumes illumination.

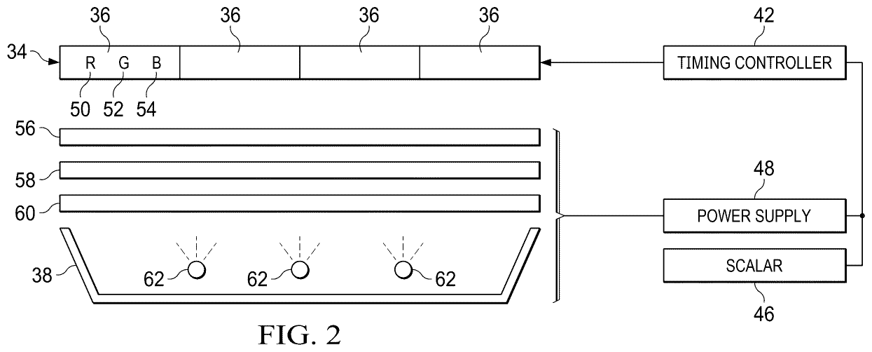

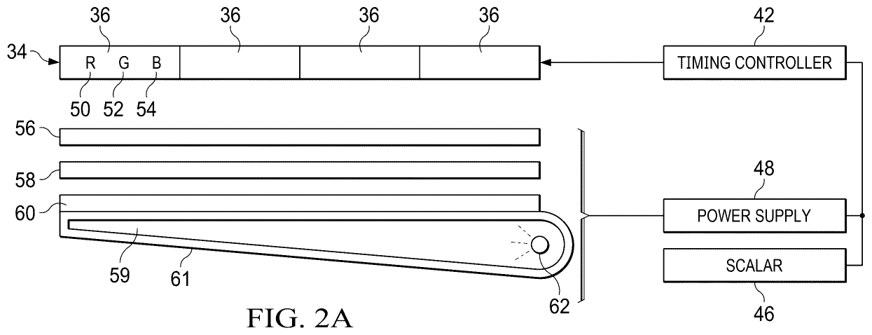

Referring now to FIGS. 2 and 2A, a block diagram depicts a display panel 34 configured to time power shut off to a display panel and backlight 38. Backlight 38 has plural LEDs 62 that generate white light, such as by combining red, green and blue light. FIG. 2 depicts a direct backlight with LEDs 62 distributed across the backside of the display panel. FIG. 2A depicts a side illumination backlight having LEDs 62 at one side of the display panel directing illumination into a light guide 59 having a reflector 61 that directs the illumination towards the display panel. Either direct or side illumination configurations may be used herein. The white light passes through a diffuser 60, diffuser sheet 58 and prism 56 and then through display panel 34 having an array of pixels 36 with red LCD material 50, green LCD material 52 and Blue LCD material 54. Scalar 46 cooperates with timing controller 42 to provide a charge at each pixel so that the red, green and blue LCD materials pass through a desired amount of light for a desired color at each pixel. When scalar 46 detects a command to power down the display, scalar 46 commands power off by the power supply to both backlight 38 and display panel 34 simultaneously so that decaying phosphor light and screen garbage are not presented. By turning off power to display panel 34 so that current stops uniformly across the array of pixels 36, the entire display transitions to a dark state in a uniform manner in the transition time of the liquid crystal material from the charged state to the off state, such as a time of 8 ms. When individual control of power supply to backlight 38 and display panel 34 are available, power may be cutoff to display panel 34 first for a transition time, such as 8 ms, and then shut off at backlight 38 so that light transmission through pixels 36 is off when the phosphor decay begins. As is described above, power cut off to display panel 34 may include analog reductions proportional with phosphor decay and to a set of pixel LCD materials as desired to manage the presentation of light through display panel 34 during power down of the display.

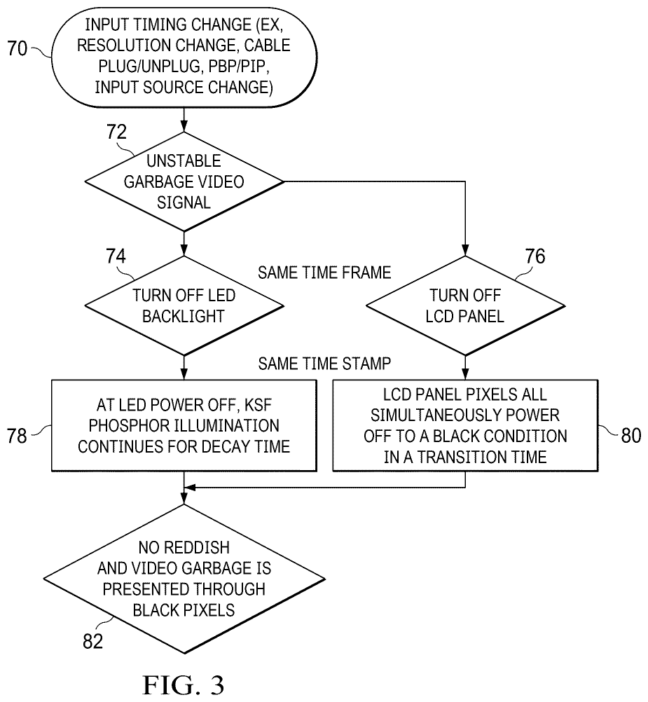

Referring now to FIG. 3, a flow diagram depicts a process for transition to power down at a display that manages visual image presentation. The process starts at step 70 with an input timing change, such as an image resolution change, a cable plug/unplug, a picture by picture or picture in picture event, an input source change, a power off command and other types of events. At step 72 in response to the event an unstable or garbage signal is generated as the video signal. At step 74 and step 76 the LED backlight and LCD panel pixels are simultaneously powered off. At step 78 when the LED backlight is powered off the KSF phosphor response continues illumination with a decay in illumination brightness over time. Simultaneously at step 80 the LCD panel pixels all turn off to a normally black condition concurrent to the LED power down and phosphor illumination of step 78. In the example embodiment, the pixel values turn full black in the absence of power in 8 ms so that the display screen goes black rather than presenting the unstable video signal information. At step 82 the display presents a blank screen without reddish garbage when all the LCD pixels have turned black. The scalar may then transition to the new input timing change operation, such as presenting another video source or powering down the display completely.

Although the present invention has been described in detail, it should be understood that various changes, substitutions and alterations can be made hereto without departing from the spirit and scope of the invention as defined by the appended claims.

1. An information handling system comprising:
a processor operable to execute instructions that process information;
a memory interfaced with the processor and operable to store the instructions and information; and
a display interfaced with the processor and having a liquid crystal display panel operable to generate visual images with an array of liquid crystal pixels illuminated by a backlight, the backlight having plural light emitting diodes to generate illumination and phosphor material to enhance illumination, the display further having a scalar that manages visual image presentation and application of power from a power supply to the backlight and the array of liquid crystal pixels, the scalar responding to an input timing change by powering off the array of pixels by cutting off power to the array of pixels from the power supply within a predetermined time of powering off the backlight.

2. The information handling system of claim 1 wherein the predetermined time of powering off the backlight comprises powering off the backlight simultaneous with powering off the array of pixels.

3. The information handling system of claim 2 wherein the phosphor comprises potassium fluorosilicate.

4. The information handling system of claim 1 wherein the predetermined time of powering off the backlight comprises powering off the array of pixels before powering off the backlight of at least a transition time for the pixels to reach an off state.

5. The information handling system of claim 4 wherein the transition time is substantially 8 ms.

6. The information handling system of claim 1 wherein the predetermined time of powering off the backlight comprises powering of the array of pixels by reducing power in proportion to the decay of illumination from the phosphor material.

7. The information handling system of claim 1 wherein the array of pixels include red, green and blue pixels, the phosphor material has a red illumination and the red pixels are powered off independently of the green and blue pixels.

8. The information handling system of claim 1 further comprising:
a power supply of the display configured to separately power the array of pixels and the backlight;
wherein the scalar interfaces with the power supply of the display to independently adjust power to the array of pixels and to the backlight at different times during transition of the display to a powered down state.

9. The information handling system of claim 1 further comprising a portable housing, the processor, memory and display included in the portable housing.

10. A method for transitioning a display to an off state, the method comprising:
generating illumination with a backlight having phosphor material to enhance the illumination;
passing the illumination through a display panel having an array of pixels that define visual images for presentation at the display panel;
detecting an input timing change; and
powering off the array of pixels within a predetermined time of powering off the backlight by cutting off current supplied to the array of pixels by a power supply.

11. The method of claim 10 further comprising turning off power to the array of pixels and the backlight simultaneously in response to detecting a power off command.

12. The method of claim 11 wherein the phosphor material comprises potassium fluorosilicate.

13. The method of claim 10 further comprising turning off power to the array of pixels and then turning off power to the backlight.

14. The method of claim 13 wherein the pixels transition to a full black in a transition time and the turning off power to the backlight is at least the transition time after turning off power to the pixels.

15. The method of claim 10 further comprising:
independently controlling power to first and second sets of pixels of the array of pixels; and
in response to the power off command, powering off the first set of pixels for a predetermined time and then powering off the second set of pixels.

16. A display comprising:
a liquid crystal display panel operable to generate visual images with an array of liquid crystal pixels;
a backlight operable to illuminate the array of liquid crystal pixels, the backlight having plural light emitting diodes to generate illumination and phosphor material to enhance the illumination; and
a scalar that manages visual image presentation, the scalar responding to an input timing change at the display by powering off the array of pixels within a predetermined time of powering off the backlight, the array of pixels having power off to all pixels simultaneously by cutting off current supplied to the array of pixels from a power supply

17. The display of claim 16 wherein the predetermined time of powering off the backlight comprises powering off the backlight simultaneous with powering off the array of pixels.

18. The display of claim 16 wherein the predetermined time of powering off the backlight comprises powering off the array of pixels before powering off the backlight of at least a transition time for the pixels to reach an off state.

19. The display of claim 16 wherein the array of pixels include red, green and blue pixels, the phosphor material has a red illumination and the red pixels are powered off independently of the green and blue pixels.

20. The display of claim 16 further comprising:
a power supply of the display configured to separately power the array of pixels and the backlight;
wherein the scalar interfaces with the power supply of the display to independently adjust power to the array of pixels and to the backlight at different times during transition of the display to a powered down state.
